(19) United States
(12) Patent Application Publication
(10) Pub. No.: US 2017/0058859 A1
(43) Pub. Date: Mar. 2, 2017

(54) FLOATING POWER PLANT WITH PADDLE WHEELS FOR THE PRODUCTION OF ELECTRICITY

(71) Applicant: POLIECO-KM OOD, Sofia (BG)

(72) Inventors: Tsonyu Mihaylov Konstantinov, Sofia (BG); Mihail Tzonev Mihaylov, Sofia (BG)

(21) Appl. No.: 15/247,436

(22) Filed: Aug. 25, 2016

(30) Foreign Application Priority Data
Aug. 26, 2015 (BG) 112082

(51) Int. Cl. F03B 17/06; H02K 7/18; B63B 35/44

(52) U.S. Cl. CPC F03B 17/067; F03B 17/063; B63B 35/44; H02K 7/1823; F05B 2220/706; F05B 2240/93; F05B 2240/20; B63B 2035/4466

(57) ABSTRACT

A floating power plant with paddle-wheels for the production of electricity, which will be utilized in the hydro power industry and mainly in the production of electricity from flowing waters, rivers, and channels. The created facility is a pontoon-type “trimaran”, including three floating bodies with vertical sides and in the shape of two mirror curvatures which connect to each other with a straight portion, and where the two end floating bodies are identical and symmetrical to the middle floating body. Each end body is half the size and shape of the middle floating body. Between the floating bodies there are two identical grooves, each groove holding a paddle-wheel. The three floating bodies are connected by a common deck, on which an electric generator is placed, coupled with a reduction gear, and connected to the major axis of each of the paddle-wheels.

### CLAIM OF PRIORITY

This application claims priority to Bulgarian Utility Model Patent No. 112082 filed Aug. 26, 2015 the contents of which are hereby fully incorporated by reference.

### FIELD OF THE EMBODIMENTS

The field of the embodiment of the present invention relates to a floating power plant with paddle wheels for the production of electricity, which will be utilized in the hydro power industry and mainly in the production of electricity from flowing water, rivers, and channels.

### BACKGROUND OF THE EMBODIMENTS

A well-known practice in producing electricity from rivers is building dams or channels for obtaining high-speed water flow, which drives electric generators. This is associated with high costs and a low profitability of the production of electricity. The kinetic energy of the middle and lower reaches of the rivers is not used under the previously applied methods mainly due to economic and environmental reasons.

From Bulgarian patent application Reg. No. 111 340, a floating power plant on flowing water with paddle wheels is described that allows the use of low-speed water flow of rivers without building additional facilities or changing the environment. The well-known floating power plant on flowing waters with paddle-wheels is a floating pontoon-type “trimaran,” including three floating bodies with vertical sides and a shape of two mirror curvatures connected to a straight part. The two end floating bodies are identical and symmetrical to the middle floating body, each end body being half the size and shape of the middle floating body. Between the floating bodies there are two identical grooves, each of which holds a paddle wheel. The three floating bodies are connected by a common deck on which an electric generator is placed, coupled with a reducing agent connected to the major axis of each of the paddle wheels. The well-known floating power plant does not reveal its construction features, leading to the efficient conversion of kinetic energy of flowing water into a torque transmitted to the generator through a gearbox to produce electricity.

A review of the related technologies reveals the following:

U.S. Pat. No. 3,746,875 teaches a four-way power plant operable to generate electrical energy both from the up and down two-directional movement of the ocean surface and also from the two-directional flow of the ocean towards and away from a shore includes fixed structure mounted on the ocean floor and a floating platform slidably connected with the fixed structure. Electricity is generated from mechanism, preferably gears, driven by the up and down movement of the platform and from other mechanism, preferably paddle wheels, driven by the flow of water directed across the platform.

U.S. Pat. No. 5,136,174 teaches a generator for electricity, utilizing one or two groups of separately placed water-driven paddlewheels placed side by side in man-made canal. Each group is coupled together by a belt embracing a plurality of drive pulleys which deliver power to central assembly pulleys on a single shaft. The central assembly pulleys each incorporate a centrifugal clutch which transmits power to flywheel device which monitors rotational speed, thereby building up angular momentum. A pulley delivers the power via a belt to a power-take-off pulley, then through a centrifugal clutch to a shaft and then to a generator.

U.S. Pat. No. 6,551,053 discloses a hydro-electric generator for producing electricity in areas of flowing water. The hydro-electric generator includes a flotation device. An electric generator is mounted on the floatation device. A paddle wheel is rotatably mounted to the floatation device. The paddle wheel is mechanically coupled to the electric generator. The floatation device is anchored in an area of flowing water such that a current rotates the paddle wheel and electricity is produced.

U.S. Pat. No. 7,969,034 teaches a minimal maintenance paddle wheel electric generation device for producing no cost electricity includes an A-frame base disposed in a fast flowing stream with a paddle wheel mounted between A-frame supports, with the supports resting on the base, and the paddle wheel including radially arranged dip blades with the rotation of the paddle wheel by the swiftly running water turning a drive gear that engages a series of reduction gears that, in turn, actuate a generator for producing electricity. A pair of paddle wheels can be ganged together on several floating members with the floating members tethered by cables to stanchions fixed on opposed banks of the stream. The paddle wheel can also be supported on buoyant inflatable tubes that have curvilinear members attached to the rear ends for directing water into the channel formed between the tubes thereby enhancing water flow and the angular speed of the paddle wheel for increased power generation.

U.S. Pat. No. 8,350,396 discloses systems, methods, apparatuses and techniques for generating energy from water current. According to one representative embodiment, an apparatus includes: a paddlewheel having multiple individual paddles, an axis of rotation, a front side that is forward of the axis of rotation, and a rear side that is behind the axis of rotation; and a covering structure having a front portion that (a) covers a first part of the front side of the paddlewheel, leaving a second part of the front side of the paddlewheel uncovered by said front portion and (b) extends a distance forward of the front side of the paddlewheel, with the front portion of the covering structure being tapered, becoming thinner as it extends further forward of the paddlewheel.

United States Patent Application Publication No 20120086207 teaches a device for transforming the energy of flowing water into useable energy. The device comprises one or more paddlewheels, and one or more generators mounted on a paddlewheel, one or more mooring lines, and a means by which to hold the device in position relative to the moving water. A subsea cable may be included to transmit the electrical energy generated by the device to shore

Various systems and methodologies are known in the art. However, their structure and means of operation are substantially different from the present disclosure. The other inventions fail to solve all the problems taught by the present disclosure that is they fail to directly absorb the kinetic energy of flowing water masses moving at a relatively low speed and turn it into easily usable torque and power. At least one embodiment of this invention is presented in the drawings below and will be described in more detail herein.

### SUMMARY OF THE EMBODIMENTS

In general, the present invention and its embodiments teach and describe a floating power plant on flowing waters with grooves and paddle wheels to directly absorb the kinetic energy of water masses moving at a relatively low speed and turn it into easily usable torque.

In one of the embodiments there is a floating power plant with paddle-wheels for the production of electricity, which will be utilized in the hydro power industry and mainly in the production of electricity from flowing waters, rivers, and channels. The created facility is a pontoon-type “trimaran”, including three floating bodies with vertical sides and a shape of two mirror curvatures connected to a straight portion, where the two end floating bodies are identical and symmetrical to the middle floating body. Each end body being half the size and shape of the middle floating body. Between the floating bodies there are two identical grooves, each groove holding a paddle-wheel. The three floating bodies are connected by a common deck, on which an electric generator is placed, coupled with a reduction gear, and connected to the major axis of each of the paddle-wheels.

Each of the grooves comprises a length (L=11 m) and width (B=10 m), so that L is two times greater than B. The curvatures start from the bow of the floating body and is a concaved part of the clothoid, passing through its inflection point in the swell of clothoid. The length of the curvature formed by the clothoid is a quarter of the length of the groove (L). The curvature passes into a straight portion with a length equal to one half of the length of the groove (L). Each paddle-wheel has a diameter (D=4.2 m) which comprises a main axis and an eccentric axis, spaced by a distance (E=0.25 m), and also comprises radial arms, which at one end are rigidly attached to the main axis, and at the other end are pivotally connected to at least one corresponding blade. The eccentric axis is connected on one end to eccentric levers via a knee hinge, and at its other end, is fixed and perpendicularly connected to at least one corresponding blade. One of the eccentric levers is rigidly connected at a right angle to the respective knee hinge and to at least one corresponding blade.

The advantages of the created invention result from the shape of the grooves and paddle-wheels. The possibility of the paddle-wheels to work in the middle straight part of the grooves with a section half the size, provides twice as much speed of the watercourse, where the absorbed kinetic energy from the water surface is easily converted into torque of the paddle-wheels. Additionally, due to the vertical sides of the floating bodies and the unique clothoid curvature, vortex generating is avoided yet vortex generating take energy from the tide to create parasitic vortices. The clothoid is a curve that provides a linear increase of the centrifugal acceleration if a body moves on this curve. Therefore a laminar water flow moving in a clothoid curve retains its character and there is no waste of kinetic energy.

The production of energy by the floating power plant with the presently described paddle-wheels is completely environmentally friendly because it does not pollute the air, doesn't produce emissions; no water pollution as no emissions of liquid substances, no pollution of the soil, and no waste. Finally the working mechanisms do not produce noise so no noise pollution. Another advantage of the product is the possibility that the floating pontoon, which can be anchored anywhere along the river, can move without interfering with navigation. Furthermore, it does not take up space from the shore and thus does not continue to shore amelioration. The fact that the floating pontoon is able to move on an instant allows for choosing a favorable area for the operation of the facility.

It is object of the system of the present invention to provide an environmentally friendly option for power creation.

A further object of the system of the present invention is the mobility of the floating power plant.

### BRIEF DESCRIPTION OF THE DRAWINGS

The present invention is illustrated in the enclosed figures, are:

FIG. 1 shows a perspective view of a floating power plant on flowing waters with paddle-wheels.

FIG. 2 shows a perspective side view of the floating power plant.

FIG. 3 shows a perspective front view of the floating power plant.

FIG. 4 shows graphical representation of the clothoid.

FIG. 5 shows an illustrative view of pontoons and the grooves between them.

FIG. 6 shows a perspective side view of a paddle-wheel.

FIG. 7 shows a perspective front view of a paddle-wheel.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The present invention comprises a floating power plant with paddle wheels for the production of electricity from flowing waters. The power plant sits on a pontoon-type “trimaran,” A trimaran being a multihull boat that comprises a main hull and two smaller outrigger hulls (or “floats”) which are attached to the main hull with lateral beams. The preferred embodiment of the present invention comprises three floating bodies with vertical sides and in the shape of two mirror curvatures which connect to each other with a straight portion. The two end floating bodies are identical and symmetrical to the middle floating body. Each end body being half the size and shape of the middle floating body. Between the floating bodies there are two identical grooves, each of which holds a paddle wheel. The three floating bodies are connected by a common deck, on which an electric generator is placed, coupled with a reducing agent connected to the major axis of each of the paddle wheels. According to the invention, each of the grooves is with a length (L) and width (B), defined as the distance between the bows of any two adjacent floating bodies, so that L is two times greater than B. The curvature starting from the bow of the floating body is a concaved portion of the clothoid. The length of the curvature, formed by the clothoid is a quarter of the length of the groove (L). The curvature, starting from the bow of the floating body, is a concave portion of the clothoid, passing through its inflection point in the swell of the clothoid. The length of the curvature, formed by the clothoid, is a quarter of the length of the groove (L). The curvature passes into a straight portion with a length equal to one half of the length of the groove (L). Each paddle wheel with the diameter (D) includes a main axis and eccentric axis spaced by a distance E, and radial arms, which at one end are rigidly attached to the main axis, and at the other end are pivotally connected to the blades. The eccentric axis is connected to eccentric levers, and connected a knee hinge with length L, which, at its other end, is fixed and perpendicularly connected to its corresponding blade. One of the eccentric levers is connected rigidly and at a right angle to the respective knee and its corresponding blade, called the leading one. The preferred embodiment of the present invention may be comprised of steel (e.g. the Bulgarian standard of CT3 or the US standard of S235JRG3, or something of the like). In another embodiment, plastic material could be used for improvement. In a preferred embodiment, at least one person may be stationed on the floating facility to monitor.

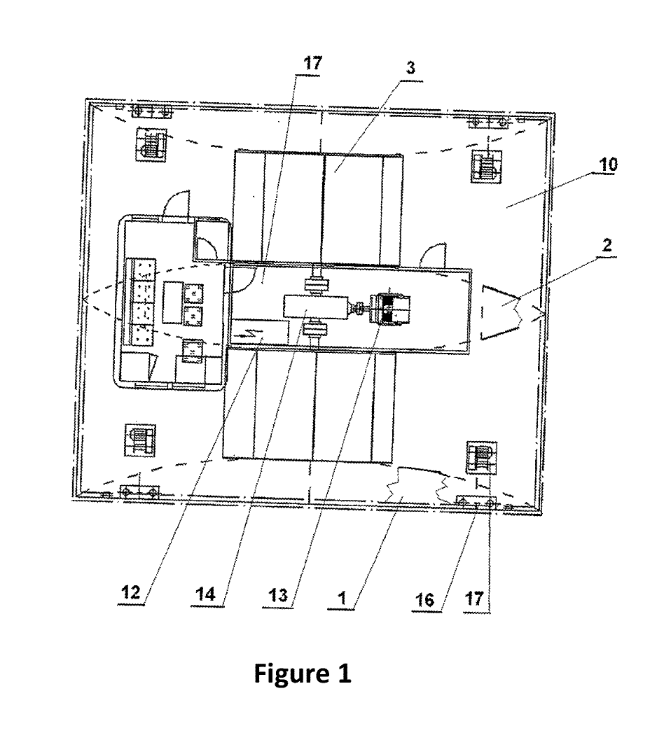

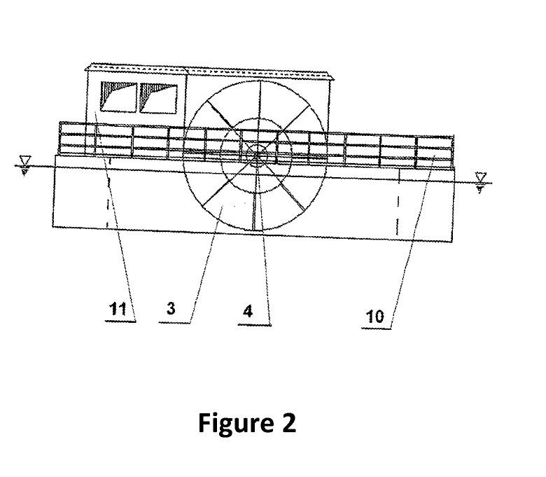

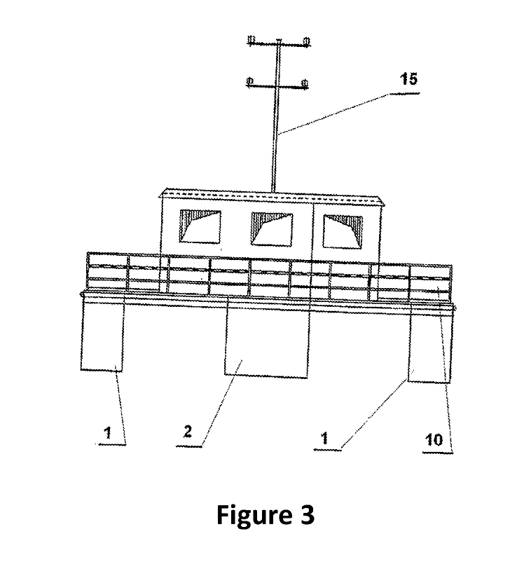

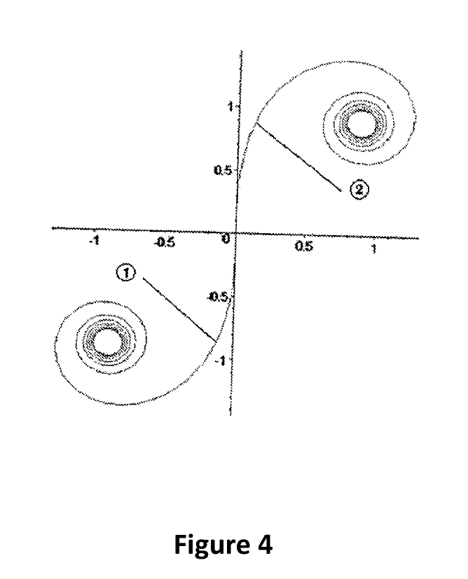

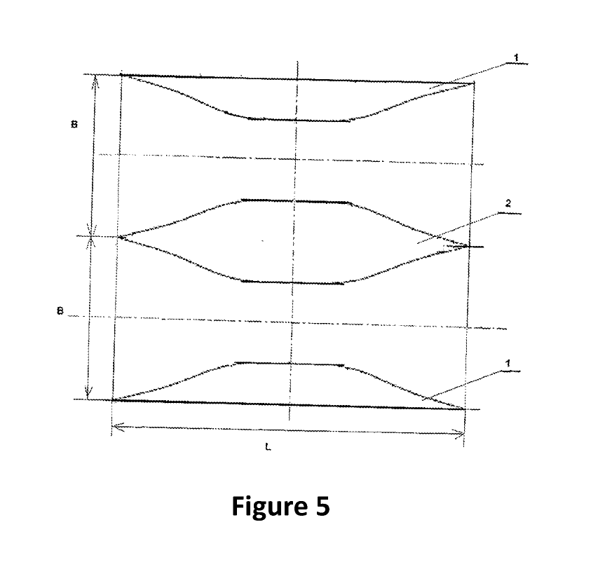

The created facility, as shown in FIGS. 1, 2, and 3, is a hauled floating pontoon-type “trimaran,” including three floating bodies, where the two end floating bodies 1 are identical and symmetrical to the middle floating body 2. Each end of body 1 is half the size and shape of the middle floating body 2. The floating bodies 1 and 2 comprise a length (L), forming two identical grooves, each holding a paddle-wheel 3. FIG. 4 shows graphical representation of the clothoid. As shown in FIG. 5, each groove comprises a length (L) and a width (B), defined as the distance between the bows of any two adjacent floating bodies, so that (L) is two times greater than (B). The floating bodies 1 and 2 are comprises of vertical sides and in the shaped of two mirror curvatures which connect to each other with a straight portion. The curvature, starting from the bow of the floating body is a concaved part of the clothoid, passing through its inflection point in the swell of clothoid. The length of the curvature, formed by the clothoid, is a quarter of the length of the groove (L). The curvature passes into a straight part with a length equal to one half of the length of the groove (L).

The cross-section of the grooves in the middle straight portion, where the paddle-wheels 3 are located, is twice smaller than the cross-section in the bow in the form of two branches of clothoid. According to the equation of continuity of watercourses S₁V₁=S₂V₂, the speed of the water flow also increases twice. Here, S₁ (m²) is the area of the inlet cross section, and V₁ (m/s) is the speed of the water flow in the inlet cross section, and S₂ (m²) is the area of the working section and V₂ (m/s) is the speed of the water flow in the working part. Additionally, due to the vertical sides of the floating bodies and the unique clothoid curvature, vortex generating is avoided yet vortex generating take energy from the tide to create parasitic vortices. The clothoid is a curve that provides a linear increase of the centrifugal acceleration if a body moves on this curve. Therefore a laminar water flow moving in a clothoid curve retains its character and there is no waste of kinetic energy.

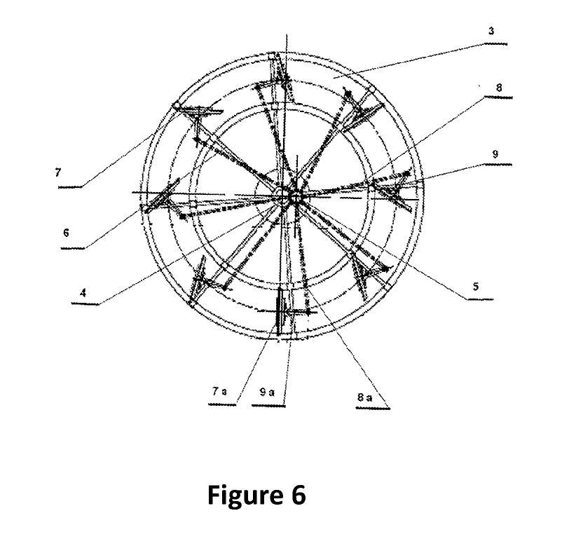

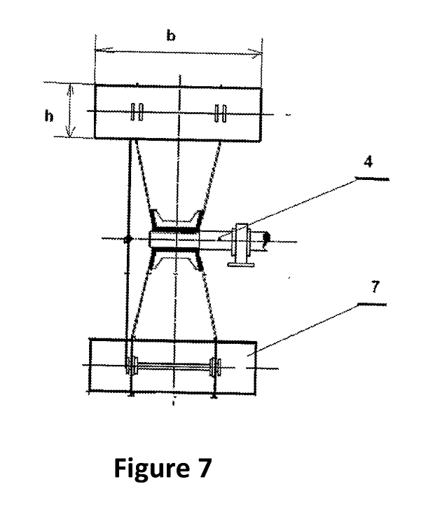

As shown in FIGS. 6 and 7, each paddle-wheel 3 with the diameter (D), is defined by the formula D=2(H+0.05), where H=2.0 m is the height of the pontoon, including the main axis 4 and the eccentric axis 5, the distance between them being “E”—called the eccentric distance. The design of the paddle-wheel 3 includes radial arms 6, which, at one end, are rigidly attached to the main axis 4, and, at the other end, are pivotally connected with the blades 7, with height (h=0.75 m) and length (b=2.5 m). The eccentric axis 5 is connected to eccentric levers 8. The eccentric levers 8 are connected to a knee hinge 9 with length (l=0.35 m), which, at its other end, is fixed and perpendicularly connected to its corresponding blade 7. One of the eccentric levers 8a is connected rigidly and at a right angle to the respective knee 9a and its corresponding blade 7a, called the leading one, ensuring in this way the vertical position of the blades 7 when in the water.

When constructing the paddle-wheel 3, the following ratios are met, defining its optimal hydraulic characteristics:
Ratio E/1=e=0.7 and is called relative eccentricity;
Ratio h/b=0.3 and determines the size of the blades
the number of blades z is not less than 6 and not greater than 8, depending on the wade of the pontoon.

In a preferred embodiment of the invention, each blade is rectangular in shape with height (h) and length (b), wherein h/b=0.3. Furthermore, the observed ratio is E/l=0.7, where l is the length of the knee hinge. In a preferred embodiment of the invention, the number of the blades (z) is not less than 6 and not larger than 8.

As shown in FIGS. 1, 2, and 3, the three floating bodies 1 and 2 are connected by a common deck 10, creating a sufficiently strong connection between the bodies. In the middle of the deck 10 a deck-house 11 is placed. The deck-house 11 houses a main panel 12, an electric generator 13 and coupled thereto a reducer 14, which is connected to the main axis 4 of the paddle-wheels 3. The produced electricity is transferred to shore by a cable, suspended on a column 15. A mooring device comprising securing elements 16, signaling equipment, and winches 17 are also provided on the floating power plant facility.

In another embodiment, lighter and cheaper materials may be used to construct the pontoon. The paddle wheels could be made of suitable plastic materials making the paddle wheels lighter. Lighter paddle means the kinetic energy of the river flow could be used more effectively and the initial investment (start-up cost) would be minimized. In another embodiment, Suitable plastic materials could be used for the structure on the deck. Such materials could be of lightweight construction and may also minimized initial investments.

In another embodiment, the paddle wheels may be attached to the floating power plant in a variety of different ways, including hinge locks and magnets. The attachment mechanisms can assure that the facility can easily be broken down and reassembled in another location. In another embodiment, the floating power plant can be automated and controlled wirelessly. The speed of the paddle wheels may be controlled wirelessly as may the attack angle of the paddle wheels in the flowing water. The location, installation, distance and direction of the facility can be remote controlled or automated. This would allow for the facility to be moved to different locations when needed and minimize staff and operating costs. In another embodiment, the eccentric levers and the secondary eccentric wheel to which they are coupled may be removed to ensure the design and construction of the paddle wheel will be lighter. In another embodiment

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A floating power plant for the production of electricity from flowing waters, comprising:
a hauled floating pontoon-type “trimaran,” comprising:
at least two paddle-wheels;
three floating bodies comprising vertical sides and in the shape of two mirror curvatures which connect to each other with a straight portion; and wherein two of the three floating bodies are located on either end and identical and symmetrical to the middle floating body, each end body being half the size and shape of the middle floating body; and
between the three floating bodies are two identical grooves, each holding at least one paddle-wheel; and wherein
the three floating bodies are connected by a common deck, on which an electric generator is placed; said electric generator coupled with a reduction gear; said reduction gear connected to the major axis of each of the at least one paddle-wheels.

2. The floating power plant of claim 1, wherein each of the two grooves comprises a length (L) and width (B), and further defined as the distance between the bows of the three floating bodies, so that L is two times greater than B.

3. The floating power plant of claim 1, wherein the curvature starting from the bow of the three floating bodies is a concaved portion of the clothoid, passing through its inflection point in the swell of the clothoid; and wherein the length of the curvature, formed by the clothoid is a quarter of the length of the groove L.

4. The floating power plant of claim 3, wherein the curvature passes into a straight part with a length equal to one half of the length of the groove L

5. The floating power plant of claim 1, wherein each of the at least two paddle wheels comprises a diameter (D), a main axis, and an eccentric axis, spaced by a distance (E), and further comprising radial arms, which, at one end, are rigidly attached to the main axis, and, at an other end, are pivotally connected to at least one blade; and
wherein the eccentric axis is connected at one end to eccentric levers via a knee hinge; and which, at the other end, is fixed and perpendicularly connected to at least one corresponding blade; and
wherein one of the eccentric levers is rigidly connected at a right angle to the knee hinge and to at least one corresponding blade.

6. The floating power plant of claim 1, wherein the at least one blade is rectangular comprising a height (h) and length (b), and where h/b equals 0.3.

7. The floating power plant of claim 1, wherein E/l equals 0.7 and wherein l is the length of the knee hinge.

8. The floating power plant of claim 1, wherein the number of the at least one blade (z) is not less than 6 and not greater than 8.
